(19) United States
(12) Patent Application Publication
(10) Pub. No.: US 2005/0257507 A1
(43) Pub. Date: Nov. 24, 2005

(54) Industrial scrap collector

(75) Inventor: Ching-Lin Tsai, Taichung County (TW)

Correspondence Address: BACON & THOMAS, PLLC, 625 SLATERS LANE, FOURTH FLOOR, ALEXANDRIA, VA, 22314, US

(73) Assignee: OAV EQUIPMENT & TOOLS, INC., TAICHUNG HSIEN (TW)

(21) Appl. No.: 10/893,363

(22) Filed: Jul. 19, 2004

(30) Foreign Application Priority Data
May 21, 2004 (TW) 93208058

(51) Int. Cl. B01D 45/18

(52) U.S. Cl. 55/428

(57) ABSTRACT

An industrial scrap collector is comprised of a separator, a ventilating device, and a chipping-collecting container. The separator includes an air chamber formed inside, an inlet formed at a side thereof for communicating the air chamber with outside, a bottom hole formed at a bottom end thereof for communicating the air chamber with outside, a guide member spirally disposed on an inner periphery of the separator and having a top end and a bottom end respectively abutting the inlet and the bottom hole. The ventilating device includes an outlet, mounted on the separator for generating an airflow flowing towards the outlet. The chipping-collecting container is mounted under the separator, including an opening formed at a top end thereof for communicating with the bottom hole of the separator. Accordingly, the industrial scrap collector can collect the chippings and dust more efficiently.

### BACKGROUND OF THE INVENTION

1. Field of the Invention

The present invention relates generally to machines of collecting chippings and dust, and more particularly to an industrial scrap collector, which works in high efficiency.

2. Description of the Related Art

A common industrial scrap collector 2, as shown in FIG. 4, is comprised of a separator 81, a ventilating device 82 mounted above the separator 81 and having components (not shown), like a motor, a fan, etc., for guiding the chippings and dust into the separator 81, a chipping-collecting container 83 mounted under separator 81 for collecting the heavier chippings and dust in the separator 81, and a dust-collecting container 84 mounted beside the separator 81 for collecting the lighter chippings and dust.

During the operation of the industrial scrap collector 2, the operator has to connect an end of a guide tube (not shown) to the inlet 811 of the separator 81 and the other end of the same to a scrap outlet of a machine tool, like a planner or a table saw, and then activate the industrial scrap collector 2 to bring he chippings and dust produced while the machine tool is working into the separator 81. In the meantime, the heavier chippings and dust in the separator 81 are subject to the gravity to fall to the chipping-collecting container 83, and the lighter chippings and dust are subject to the airflow generated by ventilating device 82 to be brought into the dust-collecting container 84, such that the primary purpose of keeping the working environment clean is attained.

However, the airflow generated inside the separator 81 by the ventilating device 82 is constantly whirly to further generate an upward pulling force (buoyancy), which draws and keeps some of the heavier chippings and dust unescaped from the separator 81 to interfere the ejection of the incoming chippings and dust from the inlet 811, thereby incurring ineffective operation of the industrial scrap collector 2.

### SUMMARY OF THE INVENTION

The primary objective of the present invention is to provide an improved industrial scrap collector, which can collect the dust more efficiently than the prior art.

The foregoing objective of the present invention is attained by the improved industrial scrap collector, which is comprised of a separator, a ventilating device, and a chipping-collecting container. The separator includes an air chamber formed inside, an inlet formed at a side thereof for communicating the air chamber with outside, a bottom hole formed at a bottom end thereof for communicating the air chamber with outside, a guide member spirally disposed on an inner periphery of the separator and having a top end and a bottom end respectively abutting the inlet and the bottom hole. The ventilating device includes an outlet, mounted on the separator for generating an airflow flowing towards the outlet. The chipping-collecting container is mounted under the separator, including an opening formed at a top end thereof for communicating with the bottom hole of the separator. Accordingly, the industrial scrap collector can collect the chippings and dust more efficiently.

### BRIEF DESCRIPTION OF THE DRAWINGS

FIG. 1 is an exploded view of a preferred embodiment of the present invention;

FIG. 2 is a perspective view of the separator according to the preferred embodiment of the present invention;

FIG. 3 is a perspective view of the preferred embodiment of the present invention; and

FIG. 4 is a perspective view of the prior art.

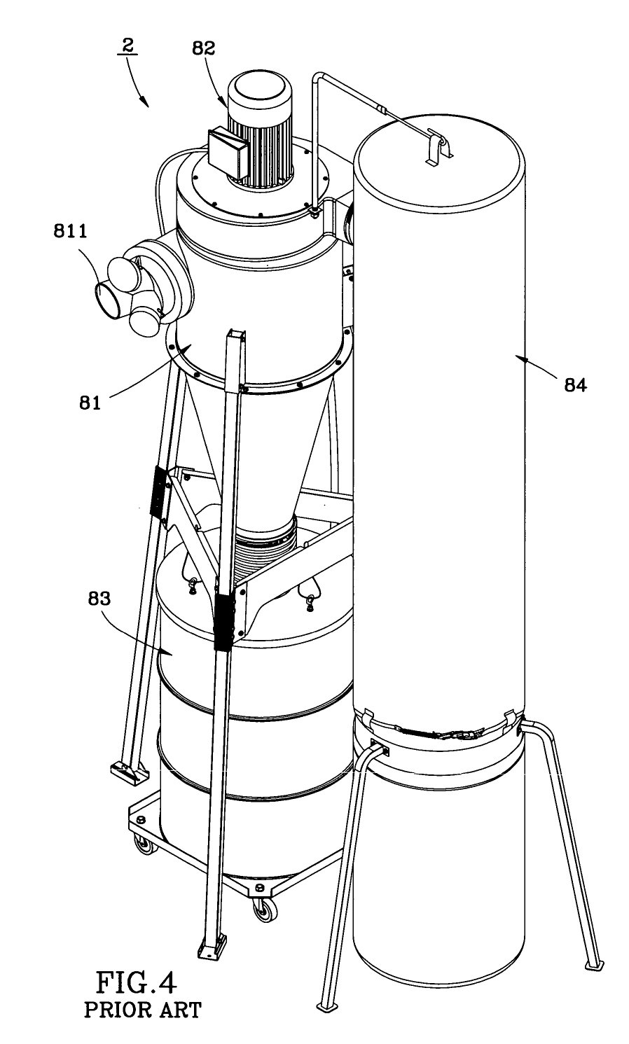

### DETAILED DESCRIPTION OF PREFERRED EMBODIMENTS

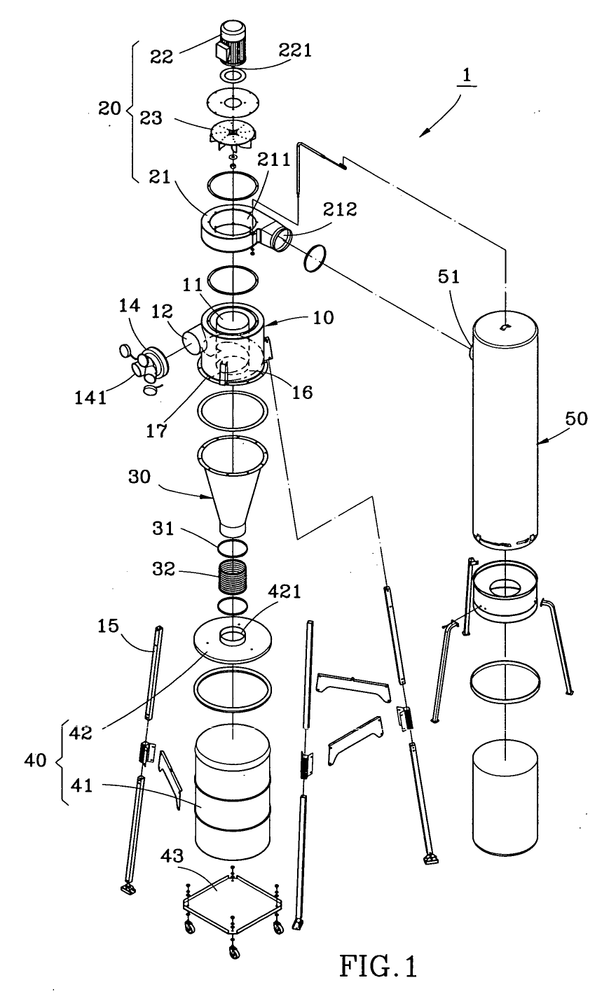

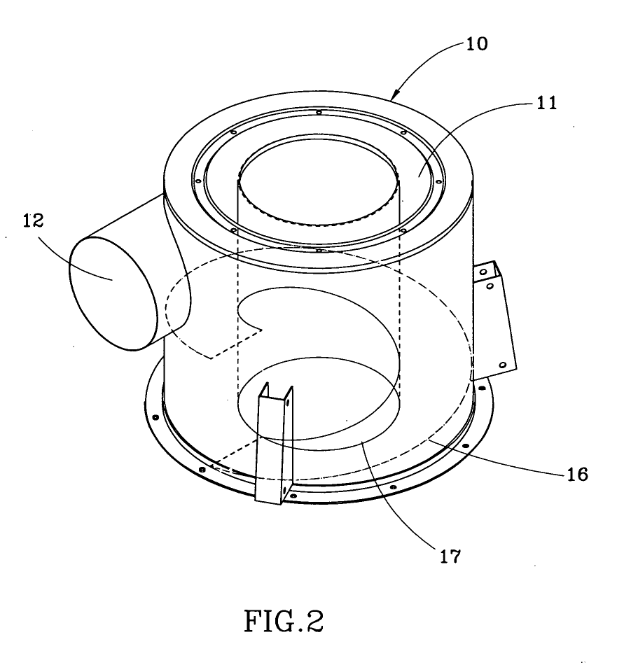

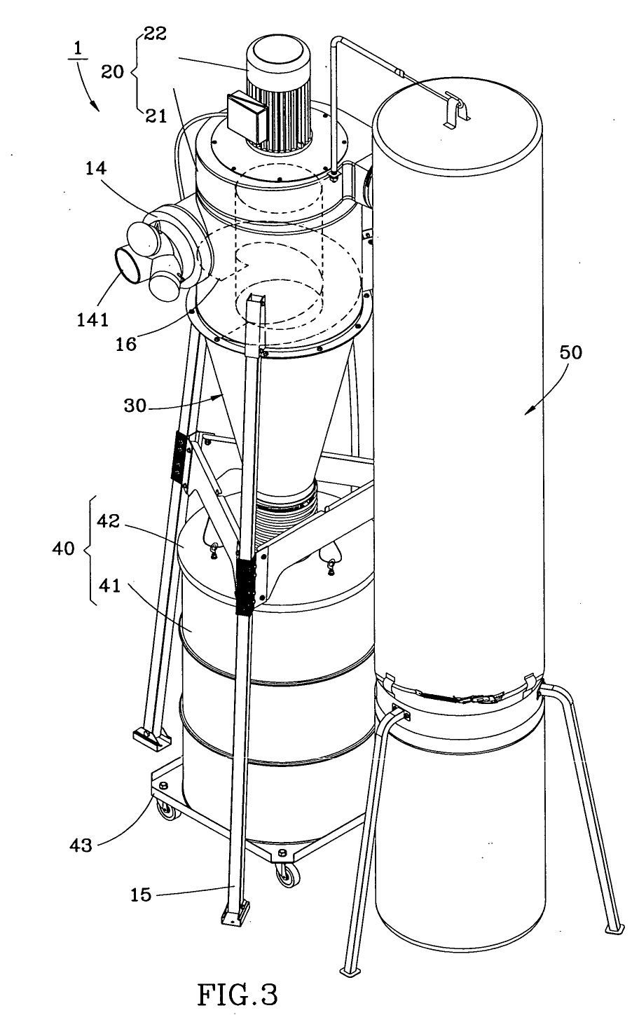

Referring to FIG. 1-3, an industrial scrap collector 1 is comprised of a separator 10, a ventilating device 20, a guide tube 30, a chipping-collecting container 40, and a dust-collecting container 50.

The separator 10 is barrel-like, including an air chamber 11 formed inside, an inlet 12 formed at a side of a top end thereof and communicating with the air chamber, a branching cap 14 mounted on the inlet 12 and having three apertures 141, a plurality of braces 15 mounted to an outer periphery thereof for supporting and fixing the separator 10 on the ground, a bottom hole 17 formed at a bottom end thereof, and a guide member 16 spirally disposed on an inner periphery thereof. Each of the apertures 141 of the branching cap 14 is connectable with a retractable pipe (not shown) to enable the industrial scrap collector 1 to work for at least three machine tools. The guide member 16 has a top end and a bottom end respectively abutting the inlet 12 and the bottom hole 17.

The ventilating device 20 includes at least one blower 21, at least one motor 22, and at least one fan 23. The blower 21 is mounted on a top end of the separator 10, having a through hole 211 running through a center thereof and an outlet 212 extending outwards from a side thereof. The motor 22 is fixedly mounted on a top end of the blower 21, having a rotational shaft 221 extending into the through hole 211 of the blower 21. When the motor 22 is activated to drive the fan 23 to rotate, the ventilating device 20 generates an airflow flowing towards the outlet 212.

The guide tube 30 is funnel-like, having a decreasing diameter from its top end to its bottom end. The top end of the guide tube 30 is connected with the bottom end of the separator 10, and the bottom end of the guide tube 30 is fitted with a retractable pipe 32 by a clamp 31.

The chipping-collecting container 40 includes a barrel-like member 41 and a lid 42 mounted on the barrel-like member 41. The lid 42 is provided with an opening 421 formed at a top end thereof and fitted to the retractable pipe 32 of the guide tube 30. A slidable rack 43 is mounted below the chipping-collecting container 41.

The dust-collecting container 50 is mounted beside the separator 10, having a side hole 51 connected with the outlet 212 of the blower 21 for collecting the lighter floating dust. Because this part is insignificant to the present invention, no further recitation is necessary.

When the motor 22 is activated, the airflow is generated while the fan 23 is rotated brings the chippings and dust into the inlet 12; meanwhile, the lighter floating dust flows along with the airflow and out of the outlet 212 to be guided and collected into the dust-collecting container 50, and the heavier chippings are subject to the rotation of the airflow and the gravity to be guided along the guide member 16 and to move downwards and to pass through the funnel-like guide tube 30 to be collected into the chipping-collecting container 50. Therefore, the chippings and dust are prevented from staying inside the air chamber 21 of the separator 10, such that the scrap collector 1 of the present invention can much efficiently collect the dust.

1. An industrial scrap collector comprising:
a separator having an air chamber, an inlet formed at a side thereof for communicating said air chamber and outside, a bottom hole formed at a bottom end thereof for communicating said air chamber and outside, and a guide member spirally connected to an inner periphery thereof and having a top end and a bottom end respectively abutting said inlet and said bottom hole of said separator;
a ventilating device mounted under said separator and having an opening formed at a top end thereof and communicating with said bottom hole of said separator; and
a chipping-collecting container mounted under said separator and having an opening formed at a top end thereof and communicating with said bottom hole of said separator.

2. The industrial scrap collector as defined in claim 1, wherein said ventilating device comprises at least one blower mounted on a top end of said separator and having a through hole and an outlet, a motor fixedly mounted on a top end of said blower and having a rotational shaft extending into said through hole of said blower, and a fan fixedly mounted to said rotational shaft of said motor, said through hole of said blower communicating with said chamber of said separator, said outlet of said blower communicating with said through hole and extending outwards from a side of said blower.

3. The industrial scrap collector as defined in claim 1, wherein said separator is connected with said chipping-collecting container by a guide tube.

4. The industrial scrap collector as defined in claim 3, wherein said guide tube is funnel-like and comprises a decreasing diameter from its top end to its bottom end, said top end and bottom end of said guide tube respectively communicating with said opening of said chipping-collecting container.

5. The industrial scrap collector as defined in claim 1 further comprises a dust-collecting container mounted beside said separator, said dust-collecting container having a side hole connected with said outlet of said ventilating device.

6. The industrial scrap collector as defined in claim 1 further comprises a slidable rack mounted below said chipping-collecting container.

7. The industrial scrap collector as defined in claim 1, wherein said separator further comprises a plurality of braces connected on an outer periphery thereof for supporting and fixing said separator on the ground.
